(19) United States
(12) Patent Application Publication
(10) Pub. No.: US 2008/0140550 A1
(43) Pub. Date: Jun. 12, 2008

(54) GENERATING A GLOBAL SYSTEM CONFIGURATION FOR A FINANCIAL MARKET DATA SYSTEM

(76) Inventors: John F. Berezuk, Georgetown, TX (US); Ronald B. Capelli, Round Rock, TX (US); John J. Duigenan, New York, NY (US); Paul E. Foreman, Austin, TX (US); Hilary A. Pike, College Station, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/567,898

(22) Filed: Dec. 7, 2006

(51) Int. Cl. G06Q 40/00; G06F 17/30

(52) U.S. Cl. 705/35; 707/104.1; 707/E17.009

(57) ABSTRACT

Methods, apparatus, and products are disclosed for generating a global system configuration for a financial market data system that include: establishing, by a configuration device, a component ruleset, the component ruleset specifying rules for component characteristics of one or more components capable of being used in financial market data systems; receiving, in the configuration device from a user through a graphical user interface, component characteristics of a specific component included in a financial market data system; storing, by the configuration device, the received component characteristics of the specific component in a global system configuration for the financial market data system; determining, by the configuration device, whether the received component characteristics satisfy the component ruleset; and supplementing, by the configuration device, the received component characteristics stored in the global system configuration with additional component characteristics in dependence upon the component ruleset if the received component characteristics do not satisfy the component ruleset.

### BACKGROUND OF THE INVENTION

1. Field of the Invention

The field of the invention is data processing, or, more specifically, methods, apparatus, and products for generating a global system configuration for a financial market data system.

2. Description of Related Art

A financial market data system is a data processing environment used to communicate information about financial markets and participants in financial markets. A financial market data system is generally composed of various hardware and software components combined for data communications using application messages or other data communications implementations as will occur to those of skill in the art. Examples of hardware and software components may include feed adapters, streams administration servers, client devices, transport engines, high-availability middleware components, conversion modules, and so on.

An application message is a quantity of data organized into one or more data fields and is passed from a message producer installed on a message sending device to a message consumer installed on a message receiving device. An application message is a form of message recognized by application software operating in the application layer of a data communication protocol stack—as contrasted for example with a transport message or network message which are forms of messages recognized in the transport layer and the network layer respectively. An application message may represent, for example, numeric or textual information, images, encrypted information, and computer program instructions. In a financial market data system, an application message is commonly referred to as a ‘tick’ and includes financial market data such as, for example, financial quotes, financial sales, or financial news. Financial quotes include bid and ask prices for any given financial security. A ‘bid’ refers to the highest price a buyer is willing to pay for a security. An ‘ask’ refers to the lowest price a seller is willing to accept for a security.

The integration of different hardware and software components into a cohesive system typically involves creating various configuration files required by each separate component. Because the configuration for each component typically has unique scope, terminology, formats, and syntax, configuring each component separately often does not express or exploit the underlying business process and application problem domain concepts that the integrated financial market data system must support. Furthermore, system administrators must exercise great care in consistently configuring each component to ensure that the various components can successfully connect, communicate, and interact to support solutions to the business processes and problem domain functions addressed by a particular financial market data system. Achieving consistent configuration among the components by manually creating the individual configuration files is often fraught with difficulty and error—especially as the complexity of the integrated system grows and software components are deployed across multiple hardware components.

To address the problems with creating configurations for each component individually, system administrators often generate a global system configuration for the entire financial market data system. The global system configuration specifies the characteristics of each of the components in the financial market data system. Such characteristics include the individual attributes of each component as well as the characteristics of the component's interface or connection with other components in the system. Using a global system configuration created for the entire financial market data system, a system administrator may then derive the individual configuration files for each of the components in the system with confidence that the derived configurations will operate consistently to support solutions to the business processes and problem domain functions addressed by the system.

The drawback to global system configurations for current financial market data systems is that system administrators typically have to create such global system configurations manually. Manually creating the global system configuration often results in semantic errors and difficulty in determining whether all component characteristics are specified correctly according to the requirements of each component. As such, readers will therefore appreciate that room for improvement exists for generating a global system configuration for a financial market data system.

### SUMMARY OF THE INVENTION

Methods, apparatus, and products are disclosed for generating a global system configuration for a financial market data system that include: establishing, by a configuration device, a component ruleset, the component ruleset specifying rules for component characteristics of one or more components capable of being used in financial market data systems; receiving, in the configuration device from a user through a graphical user interface, component characteristics of a specific component included in a financial market data system; storing, by the configuration device, the received component characteristics of the specific component in a global system configuration for the financial market data system; determining, by the configuration device, whether the received component characteristics satisfy the component ruleset; and supplementing, by the configuration device, the received component characteristics stored in the global system configuration with additional component characteristics in dependence upon the component ruleset if the received component characteristics do not satisfy the component ruleset.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network and a block diagram illustrating an exemplary system for generating a global system configuration for a financial market data system according to exemplary embodiments of the present invention.

FIG. 2 sets forth a block diagram of automated computing machinery comprising an exemplary configuration device useful in generating a global system configuration for a financial market data system according to exemplary embodiments of the present invention.

FIG. 3 sets forth a flowchart illustrating an exemplary method for generating a global system configuration for a financial market data system according to exemplary embodiments of the present invention.

FIG. 4 sets forth a flowchart illustrating an exemplary method for supplementing, by the configuration device, the received component characteristics stored in the global system configuration with additional component characteristics in dependence upon the component ruleset if the received component characteristics do not satisfy the component ruleset useful in generating a global system configuration for a financial market data system according to exemplary embodiments of the present invention.

FIG. 5 sets forth a flowchart illustrating a further exemplary method for generating a global system configuration for a financial market data system according to exemplary embodiments of the present invention.

FIG. 6 sets forth a flowchart illustrating a further exemplary method for generating a global system configuration for a financial market data system according to exemplary embodiments of the present invention.

### DETAILED DESCRIPTION OF EXEMPLARY EMBODIMENTS

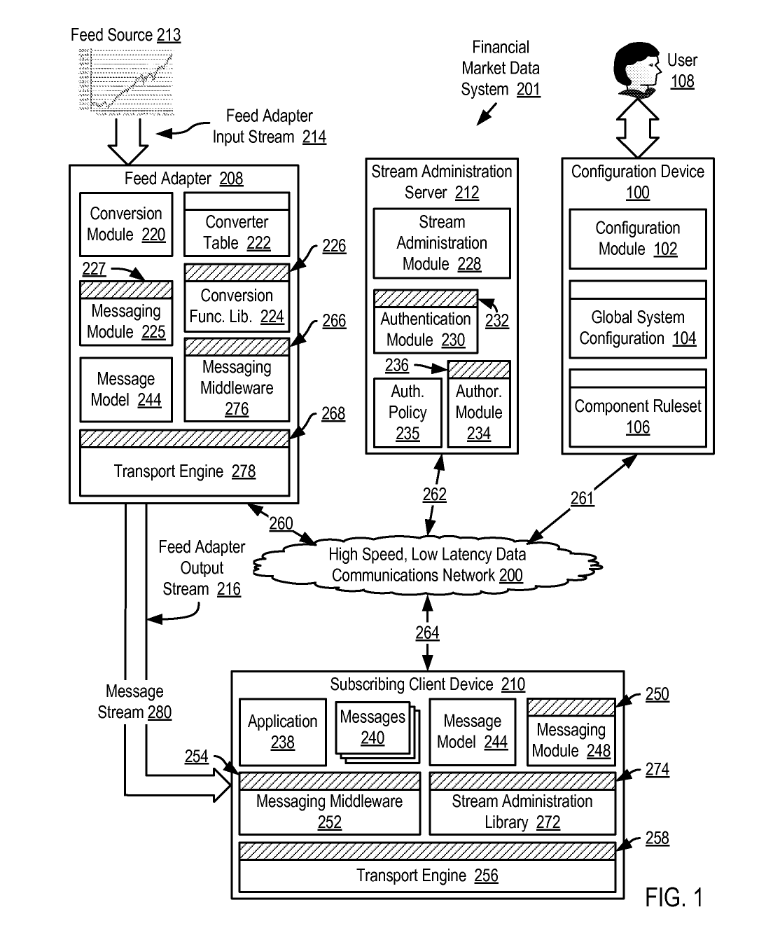

Exemplary methods, apparatus, and products for generating a global system configuration for a financial market data system according to embodiments of the present invention are described with reference to the accompanying drawings, beginning with FIG. 1. FIG. 1 sets forth a network and a block diagram illustrating an exemplary system for generating a global system configuration for a financial market data system according to embodiments of the present invention. The system of FIG. 1 operates generally to generating a global system configuration for a financial market data system according to embodiments of the present invention as follows: A configuration device (100) establishes a component ruleset (106). The component ruleset (106) specifies rules for component characteristics of one or more components capable of being used in financial market data systems. The configuration device (100) receives, from a user (108) through a graphical user interface (‘GUI’), component characteristics of a specific component included in a financial market data system. The configuration device (100) stores the received component characteristics of the specific component in a global system configuration (104) for the financial market data system. The configuration device (100) determines whether the received component characteristics satisfy the component ruleset (106). The configuration device (100) supplements the received component characteristics stored in the global system configuration (104) with additional component characteristics in dependence upon the component ruleset (106) if the received component characteristics do not satisfy the component ruleset (106).

The financial market data system (201) illustrated in FIG. 1 includes a high speed, low latency data communications network (200). The network (200) includes a configuration device (100), a feed adapter (208), a stream administration server (212), and a subscribing client device (210), as well as the infrastructure for connecting such devices (208, 212, 210) together for data communications. The network (200) of FIG. 1 is termed ‘high speed, low latency’ because the application messages sent between devices connected to the network (200) on message streams administered by the stream administration server (212) bypass the stream administration server (212). For example, the application messages on the message stream (280) from the feed adapter (208) to the subscribing client device (210) bypass the stream administration server (212). Although such messages are not delayed for processing in the stream administration server (212), the stream administration server (212) retains administration of the stream (280) between devices connected to the high speed, low latency data communications network (200).

Further contributing to the ‘high speed, low latency’ nature of network (200), readers will note that the network (200) does not include a router, that is a computer networking device whose primary function is to forward data packets across a network toward their destinations. Rather, each device (100, 208, 212, 210) provides its own routing functionality for data communication through a direct connection with the other devices connected to the network (200). Because the network (200) does not include a computer networking device dedicated to routing data packets, the network (200) of FIG. 1 may be referred to as a ‘minimally routed network.’ Although the exemplary network (200) illustrated in FIG. 1 does not include a router, such a minimally routed network is for explanation only. In fact, some high speed, low latency networks useful in generating a global system configuration for a financial market data system according to embodiments of the present invention may include a router.

The exemplary system of FIG. 1 includes a configuration device (100) connected to the high speed, low latency data communications network (200) through a wireline connection (261). The configuration device (100) of FIG. 1 is a computer device having installed upon it a configuration module (102). The configuration device (100) in the example of FIG. 1 also has installed upon it a global system configuration (104) and a component ruleset (106). Although the configuration device (100) of FIG. 1 is depicted as a device distinct from the other devices (208, 210, 212), readers will note that such a distinction is for explanation and not for limitation. In fact, any of the other devices (208, 210, 212) of FIG. 1 may also operate as a configuration device (100) provided the other device has installed upon it a configuration module (102) that operates for generating a global system configuration for a financial market data system according to embodiments of the present invention.

In the exemplary system of FIG. 1, the configuration module (102) is a software component that includes a set of computer program instructions for generating a global system configuration for a financial market data system according to embodiments of the present invention. The configuration module (102) operates generally for generating a global system configuration for a financial market data system according to embodiments of the present invention by establishing a component ruleset (106) that specifies rules for component characteristics (304) of one or more components capable of being used in financial market data systems, receiving, from a user (108) through a graphical user interface, component characteristics of a specific component included in a financial market data system, storing the received component characteristics of the specific component in a global system configuration (104) for the financial market data system, determining whether the received component characteristics satisfy the component ruleset (106), and supplementing the received component characteristics stored in the global system configuration (104) with additional component characteristics in dependence upon the component ruleset (106) if the received component characteristics do not satisfy the component ruleset (106). To receive component characteristics from the user (108) as mentioned above, the configuration module (102) provides the user with a GUI for interacting with the configuration module (102). In addition to generating a global system configuration for a financial market data system according to embodiments of the present invention, the configuration module (102) of FIG. 1 also includes a set of computer program instructions for deriving individual configuration files for each of the components in the financial market data system (201) from the global system configuration (104) and distributing those individual configuration files to the proper component in the system (201).

The global system configuration (104) of FIG. 1 is a data structure that specifies the configuration of a financial market data system and its constituent components. The global system configuration (104) of FIG. 1 specifies the configuration of a financial market data system using the component characteristics for the individual components included in the financial market data system (201) and characteristics of the inputs and outputs of the system (201). Such characteristics include the individual attributes of each component as well as the characteristics of the component's interface or connection with other components in the system. In such a manner, the global system configuration (104) operates to model the flow of data among the components of the financial market data system. Using the global system configuration (104), the configuration module (102) may derive individual configuration files for each of the hardware and software components included in the financial market data system (201) of FIG. 1. A global system configuration may be implemented using a structured document, such as, for example, an XML document, a Java object, C++ object, or any other implementation as will occur to those of skill in the art.

The component ruleset (106) of FIG. 1 is a data structure that specifies rules for component characteristics of one or more components capable of being used in financial market data systems. The component ruleset (106) serves as a repository for information regarding the configuration of such components. The component ruleset (106) may specify for a particular component that some component characteristics must be specified by a user if the component is included in a financial market data system, while the specification of other component characteristics by the user is optional. Whether a component characteristics must be specified by a user may change depending on other components included in the financial market data system. In such a manner, the component ruleset (106) may specify rules for some component characteristics for a particular component in dependence upon the other components included in the system. Furthermore, the component ruleset (106) may also specify a rule that an additional component is required in the financial market data system when a particular component with particular component characteristics is included in the system. In the example of FIG. 1, the component ruleset (106) may be implemented using a structured document, such as, for example, an XML document, a Java object, C++ object, or any other implementation as will occur to those of skill in the art.

As mentioned above, a financial market data system is generally composed of various hardware and software components combined for data communications. A more detailed description of the various hardware and software components in an exemplary financial market data system and the data communications among them is now set forth below.

The financial market data system (201) depicted in FIG. 1 includes a message stream (280). A message stream is a data communication channel between a communications endpoint of a sending device and a communications endpoint of at least one receiving device. A communications endpoint is composed of a network address and a port for a sending device or a receiving device. A message stream may be implemented as a multicast data communication channel. In a multicast data communication channel, a one-to-many relationship exists between a destination address for a message and the communication endpoints of receiving devices. That is, each destination address identifies a set of communication endpoints for receiving devices to which each message of the stream is replicated. A multicast data communication channel may be implemented using, for example, the User Datagram Protocol (‘UDP’) and the Internet Protocol (‘IP’). In addition to a multicast data communication channel, the message stream may be implemented as a unicast data communication channel. In a unicast data communication channel, a one-to-one relationship exists between a destination address for a message and a communication endpoint of a receiving device. That is, each destination address uniquely identifies a single communication endpoint of single receiving device. A unicast data communication channel may be implemented using, for example, the Transmission Control Protocol (‘TCP’) and IP.

The exemplary system of FIG. 1 includes a stream administration server (212) connected to the high speed, low latency data communications network (200) through a wireline connection (262). The stream administration server (212) of FIG. 1 is a computer device having installed upon it a stream administration module (228), an authentication module (230), an authorization module (234), and an authorization policy (235). A stream administration module (228) is a software component that includes a set of computer program instructions configured for administering message streams between feed adapters and client devices. A stream administration module (228) may administer the message streams by brokering establishment of a message stream (280) from the message sending device to a message receiving device. The message stream (280) provides the application messages to the subscribing client device (210) from the feed adapter (208).

The authentication module (230) of FIG. 1 is a set of computer program instructions capable of providing authentication security services to the stream administration module (228) through an exposed authentication application programming interface (‘API’) (232). Authentication is a process of verifying the identity of an entity. In the exemplary system of FIG. 1, the authentication module (230) verifies the identity of the subscribing client device (210). The authentication module (230) may provide authentication security services using a variety of security infrastructures such as, for example, shared-secret key infrastructure or a public key infrastructure.

The authorization module (234) of FIG. 1 is a set of computer program instructions capable of providing authorization security services to the stream administration module (228) through an exposed authorization API (236). Authorization is a process of only allowing resources to be used by resource consumers that have been granted authority to use the resources. In the example of FIG. 1, the authorization module (234) identifies the application messages that the subscribing client device (210) is authorized to receive on the message stream (280). The authorization module (234) of FIG. 1 provides authorization security services using an authorization policy (235). The authorization policy (235) is a set of rules governing the privileges of authenticated entities to send or receive application messages on a message stream. In a financial market data system, for example, an authenticated entity may be authorized to receive application messages that include financial quotes for some financial securities but not other securities. The authorization policy (235) may grant privileges on the basis of an individual entity or an entity's membership in a group.

In the exemplary system of FIG. 1, feed adapter (208) is connected to the high speed, low latency data communications network (200) through a wireline connection (260). The feed adapter (208) is a computer device having the capabilities of converting application messages received on a feed adapter input stream (214) having a first format to application messages having a second format for transmission on a feed adapter output stream (216) to subscribing client devices. The feed adapter input stream (214) is a message stream from a feed source to the feed adapter (208). The feed adapter output stream (216) is a message stream administered by the stream administration server (212) from the feed adapter (208) to the subscribing client device (210).

In the example of FIG. 1, the feed adapter (208) receives application messages on the feed adapter input stream (214) from a feed source (213). The feed source (213) is a computer device capable of aggregating data into application messages and transmitting the messages to a feed adapter. In a financial market data system, for example, a feed source (213) may be implemented as a feed source controlled by the Options Price Reporting Authority (‘OPRA’). OPRA is the securities information processor for financial market information generated by the trading of securities options in the United States. The core information that OPRA disseminates is last sale reports and quotations. Other examples of feed sources in financial market data system may include feed sources controlled by the Consolidated Tape Association (‘CTA’) or The Nasdaq Stock Market, Inc. The CTA oversees the dissemination of real-time trade and quote information in New York Stock Exchange and American Stock Exchange listed securities. The Nasdaq Stock Market, Inc. operates the NASDAQ Market Center^{SM} which is an electronic screen-based equity securities market in the United States. In a financial market data system, a feed adapter input stream is referred to as a ‘financial market data feed.’

The feed adapter (208) of FIG. 1 has installed upon it a conversion module (220), a converter table (222), conversion function library (224), a messaging module (225), a message model (244), messaging middleware (276), and a transport engine (278). The conversion module (220) is a set of computer program instructions for converting application messages received on the feed adapter input stream (214) having a first format into application messages (240) having a second format for transmission to subscribing devices on the feed adapter output stream (216).

The conversion module (220) converts application messages from the first format to the second format according to the converter table (222). The converter table (222) of FIG. 1 is a data structure that specifies the converter functions capable of converting the application message from one format to another format. Utilizing multiple converter tables, the conversion module (220) may convert messages from a variety of input formats to a variety of output formats. In the example of FIG. 1, the converter table (222) specifies the converter functions capable of converting the application message received from the feed adapter input stream (214) having the first format to application messages (240) having the second format for transmission to subscribing client devices on the feed adapter output stream (216). The converter table (222) of FIG. 1 may be implemented using a structured document such as, for example, an eXtensible Markup Language (‘XML’) document.

The conversion function library (224) of FIG. 1 is a loadable software module that contains one or more converter functions capable of converting data fields in an application message from one format to another format or converting values of data fields from one value to another value. The converter functions contained in the conversion function library may, for example, convert a 16-bit integer to a 32-bit integer, convert a number stored in a string field to a 64-bit double floating point value, increase the value of one data field by one, or any other conversion as will occur to those of skill in the art. The conversion module (220) accesses the converter functions through a set of converter function APIs (226) exposed by the converter functions of the conversion function library (224). In the example of FIG. 1, the conversion function library (224) may be implemented as dynamically linked libraries available to the conversion module (220) at runtime, statically linked libraries linked into the conversion module (220) at compile time, dynamically loaded Java classes, or any other implementation as will occur to those of skill in the art.

In the example of FIG. 1, the application messages (240) transmitted by the feed adapter (208) have a format specified in a message model (244). The message model (244) is metadata that defines the structure and the format used to create, access, and manipulate the application messages (240) converted from the application messages (not shown) received from the feed source (213). In the example of FIG. 1, the message model (244) is established on both the feed adapter (208) and the subscribing client device (210) by the stream administration server (212) when the stream administration server (212) brokers a message stream to a subscribing client device. A message model may be implemented using a structured document, such as, for example, an XML document, a Java object, C++ object, or any other implementation as will occur to those of skill in the art.

In the example of FIG. 1, the conversion module (220) and the converter functions of the conversion function library (224) process the data contained in the application messages (240) using the messaging module (225). The messaging module (225) is a software module that includes a set of functions for creating, accessing, and manipulating messages (240) according to a message model (244). The messaging module (225) is accessible to the conversion module (220), the converter functions of the conversion function library (224), and the messaging middleware (276) through a message API (227) exposed by the messaging module (225).

Before the conversion module (220) of FIG. 1 performs data processing on the application messages, the conversion module (220) receives application messages (not shown) having a first format from the feed source (213). The conversion module (220) of FIG. 1 may receive the source stream messages through a receiving transport engine (not shown) of the feed adapter (208). The receiving transport engine is a software module that operates in the transport layer of the network stack and may be implemented according to the TCP/IP protocols, UDP/IP protocols, or any other data communication protocol as will occur to those of skill in the art. The receiving transport engine may provide the received application messages directly to the conversion module (220) or to the messaging middleware (276), which in turn, provides the source stream messages to the conversion module (220).

After the conversion module (220) of FIG. 1 performs data processing on the application messages received from the feed source (213), the conversion module (220) provides the application messages having the second format to the messaging middleware (276). The messaging middleware (276) of FIG. 1 is a software component that provides high availability services between the feed adapter (208), any backup feed adapter that may exist, the subscribing client device (210), and the feed source (213). In addition, the messaging middleware (276) of FIG. 1 also provides administrative services regarding the application messages such as, for example, receiving application messages from the conversion module (220), inserting sequence numbers into the application messages, and providing the received application messages to the transport engine (278) for transmission to a subscribing client device (210) on the feed adapter output stream (216). The conversion module (220) interacts with the messaging middleware (276) through a messaging middleware API (266) exposed by the messaging middleware (276).

The transport engine (278) of FIG. 1 is a software component operating in the transport and network layers of the OSI protocol stack promulgated by the International Organization for Standardization. The transport engine (278) provides data communications services between network-connected devices. The transport engine may be implemented according to the UDP/IP protocols, TCP/IP protocols, or any other data communications protocols as will occur to those of skill in the art. The transport engine (278) is a software module that includes a set of computer program instructions for receiving application messages from the messaging middleware (276) and transmitting the application messages to the subscribing client device (210) on the message stream (280). The transport engine (278) transmits the application messages (240) to the subscribing client device (210) by encapsulating the application messages provided by the messaging middleware (276) into transport packets and transmitting the packets through the message stream (280) to the subscribing client device (210). The messaging middleware (276) operates the transport engine (278) through a transport API (268) exposed by the transport engine (278).

The subscribing client device (210) in exemplary system of FIG. 1 connects to the high speed, low latency data communications network (200) through a wireline connection (264). The subscribing client device (210) of FIG. 1 is a computer device capable of subscribing to the message streams transmitted by various feed adapters. In a financial market data system, for example, a subscribing client device may subscribe to a tick to receive the bid and ask prices for a particular security on a message stream provided by a feed adapter controlled by a financial securities broker.

In the example of FIG. 1, the subscribing client device (210) has installed upon it an application (238), a messaging module (248), a message model (244), messaging middleware (252), a stream administration library (272), and a transport engine (256). The application (238) is a software component that processes data contained in the application messages (240) received from the feed adapter (208). The application (238) may process the data for utilization by the subscribing client device (210) itself, for contributing the data to another feed adapter, or for contributing the data to some other device. In a financial market data system, the application installed on the subscribing client device may be a program trading application that buys or sells financial securities based on the quoted prices contained in ticks. The application may also be a value-adding application that contributes information to a tick such as, for example, the best bid and ask prices for a particular security, that is not typically included in the ticks provided by the feed source (213). The subscribing client device may then transmit the ticks to a feed adapter for resale to other subscribing client devices.

The application (238) processes the data contained in the application messages (240) using the messaging module (248). The messaging module (248) is software module that includes a set of functions for creating, accessing, and manipulating messages (240) according to the message model (244) that is installed on both the feed adapter (208) and the subscribing client device (210). The messaging module (248) is accessible to the application (238) through a message API (250) exposed by the messaging module (248).

The communications between the subscribing client device (210) and the stream administration server (212) may be implemented using a stream administration library (272). The stream administration library (272) is a set of functions contained in dynamically linked libraries or statically linked libraries available to the application (238) through a stream administration library API (274). Through the stream administration library (272), the subscribing client device (210) of FIG. 1 may request to subscribe to messages from a feed adapter, modify an existing message subscription, or cancel a subscription. Functions of the stream administration library (272) used by the application (238) may communicate with the stream administration server (212) through network (200) by calling member methods of a CORBA object, calling member methods of remote objects using the Java Remote Method Invocation (‘RMI’) API, using web services, or any other communication implementation as will occur to those of skill in the art.

‘CORBA’ refers to the Common Object Request Broker Architecture, a computer industry specifications for interoperable enterprise applications produced by the Object Management Group (‘OMG’). CORBA is a standard for remote procedure invocation first published by the OMG in 1991. CORBA can be considered a kind of object-oriented way of making remote procedure calls, although CORBA supports features that do not exist in conventional RPC. CORBA uses a declarative language, the Interface Definition Language (“IDL”), to describe an object's interface. Interface descriptions in IDL are compiled to generate ‘stubs’ for the client side and ‘skeletons’ on the server side. Using this generated code, remote method invocations effected in object-oriented programming languages, such as C++ or Java, look like invocations of local member methods in local objects.

The Java™ Remote Method Invocation API is a Java application programming interface for performing remote procedural calls published by Sun Microsystems™. The Java™ RMI API is an object-oriented way of making remote procedure calls between Java objects existing in separate Java™ Virtual Machines that typically run on separate computers. The Java™ RMI API uses a remote procedure object interface to describe remote objects that reside on the server. Remote procedure object interfaces are published in an RMI registry where Java clients can obtain a reference to the remote interface of a remote Java object. Using compiled ‘stubs’ for the client side and ‘skeletons’ on the server side to provide the network connection operations, the Java™ RMI allows a Java client to access a remote Java object just like any other local Java object.

Before the application (238) processes the data contained in the application messages (240), the application (238) receives the messages (240) from the messaging middleware (252), which, in turn, receives the application messages (240) from the feed adapter (208) through the transport engine (256). The messaging middleware (252) is a software component that provides high availability services between the subscribing client device (210), the feed adapter (208), any backup feed adapters, and the stream administration module (212). In addition, the messaging middleware (252) of FIG. 1 also provides administrative services regarding the application messages such as, for example, filtering application message received from the feed adapter (208) according to constraints provided by the stream administration server (212). The application (238) and the stream administration library (272) interact with the messaging middleware (252) through a messaging middleware API (254).

The transport engine (256) of FIG. 1 is a software component operating in the transport and network layers of the OSI protocol stack promulgated by the International Organization for Standardization. The transport engine (256) provides data communications services between network-connected devices. The transport engine may be implemented according to the UDP/IP protocols, TCP/IP protocols, or any other data communications protocols as will occur to those of skill in the art. In the example of FIG. 1, the transport engine (256) includes a set of computer program instructions for receiving transport packets from the feed adapter (208), unencapsulating the application messages (240) from the transport packets, and providing the message (240) to the messaging middleware (252). The messaging middleware (252) of FIG. 1 operates the transport engine (256) through a transport API (258) exposed by the transport engine (256).

Readers will note that the servers and other devices illustrated in the exemplary system of FIG. 1 are for explanation, not for limitation. Devices useful in generating a global system configuration for a financial market data system may be implemented using general-purpose computers, such as, for example, computer servers or workstations, hand-held computer devices, such as, for example, Personal Digital Assistants (‘PDAs’) or mobile phones, or any other automated computing machinery configured for data processing according to embodiments of the present invention as will occur to those of skill in the art.

The arrangement of servers and other devices making up the exemplary system illustrated in FIG. 1 is also for explanation, not for limitation. Although the connections to the network (200) of FIG. 1 are depicted and described in terms of wireline connections, readers will note that wireless connections may also be useful according to various embodiments of the present invention. Furthermore, data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example Transmission Control Protocol (‘TCP’), Internet Protocol (‘IP’), HyperText Transfer Protocol (‘HTTP’), Wireless Access Protocol (‘WAP’), Handheld Device Transport Protocol (‘HDTP’), and others as will occur to those of skill in the art. Various embodiments of the present invention may be implemented on a variety of hardware platforms in addition to those illustrated in FIG. 1.

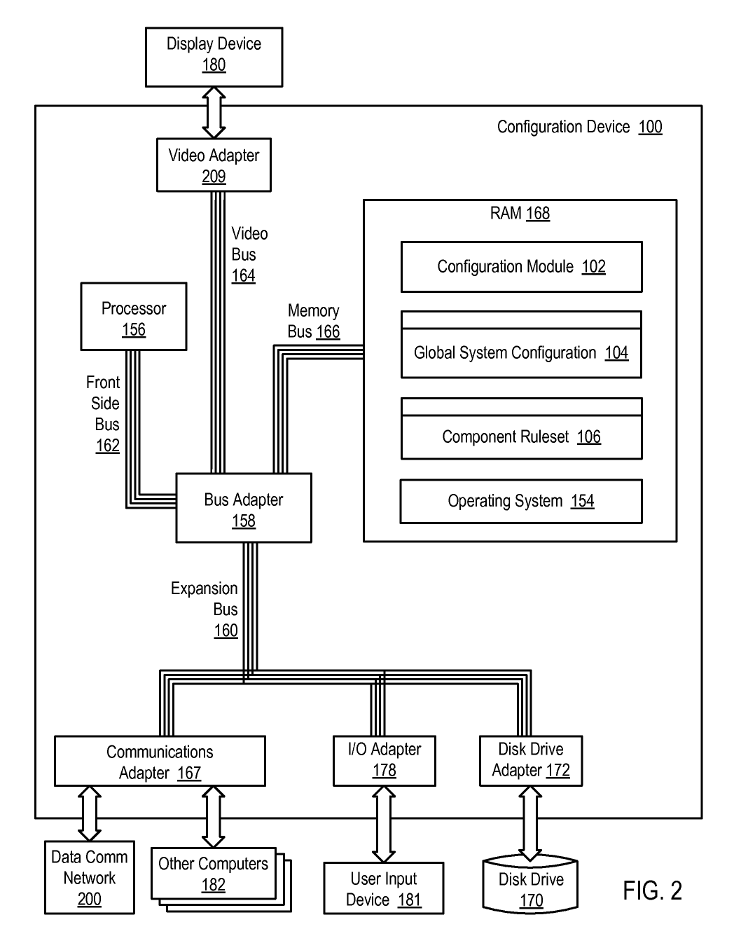

Generating a global system configuration for a financial market data system in accordance with the present invention in some embodiments may be implemented with a configuration device. Such a device is, in turn, implemented to some extent at least as computers, that is, automated computing machinery. For further explanation, therefore, FIG. 2 sets forth a block diagram of automated computing machinery comprising an exemplary configuration device (100) useful in generating a global system configuration for a financial market data system according to embodiments of the present invention. The configuration device (100) of FIG. 2 includes at least one computer processor (156) or ‘CPU’ as well as random access memory (168) (‘RAM’) which is connected through a high speed memory bus (166) and bus adapter (158) to processor (156) and to other components of the configuration device.

Stored in RAM (168) are a configuration module (102), a global system configuration (104), and a component ruleset (106). The configuration module (102) illustrated in FIG. 2 is a software component, that is computer program instructions, that operates as described above with reference to FIG. 1. The global system configuration (104) is a data structure that specifies the configuration of a financial market data system and its constituent components. A global system configuration may be implemented using a structured document, such as, for example, an XML document, a Java object, C++ object, or any other implementation as will occur to those of skill in the art. The component ruleset (106) is a data structure that specifies rules for component characteristics of one or more components capable of being used in financial market data systems. The component ruleset (106) may also be implemented using a structured document, such as, for example, an XML document, a Java object, C++ object, or any other implementation as will occur to those of skill in the art.

Also stored in RAM (168) is an operating system (154). Operating systems useful in configuration devices according to embodiments of the present invention include UNIX™, Linux™, Microsoft NT™, IBM's AIX™, IBM's i5/OS™, and others as will occur to those of skill in the art. The operating system (154), the configuration module (102), the global system configuration (104), and the component ruleset (106) in the example of FIG. 2 are shown in RAM (168), but many components of such software typically are stored in non-volatile memory also, for example, on a disk drive (170).

The exemplary configuration device (100) of FIG. 2 includes bus adapter (158), a computer hardware component that contains drive electronics for high speed buses, the front side bus (162), the video bus (164), and the memory bus (166), as well as drive electronics for the slower expansion bus (160). Examples of bus adapters useful in configuration devices useful according to embodiments of the present invention include the Intel Northbridge, the Intel Memory Controller Hub, the Intel Southbridge, and the Intel I/O Controller Hub. Examples of expansion buses useful in configuration devices useful according to embodiments of the present invention may include Peripheral Component Interconnect (‘PCI’) buses and PCI Express (‘PCIe’) buses.

The exemplary configuration device (100) of FIG. 2 also includes disk drive adapter (172) coupled through expansion bus (160) and bus adapter (158) to processor (156) and other components of the exemplary configuration device (100). Disk drive adapter (172) connects non-volatile data storage to the exemplary configuration device (100) in the form of disk drive (170). Disk drive adapters useful in configuration devices include Integrated Drive Electronics (‘IDE’) adapters, Small Computer System Interface (‘SCSI’) adapters, and others as will occur to those of skill in the art. In addition, non-volatile computer memory may be implemented for a configuration device as an optical disk drive, electrically erasable programmable read-only memory (so-called ‘EEPROM’ or ‘Flash’ memory), RAM drives, and so on, as will occur to those of skill in the art.

The exemplary configuration device (100) of FIG. 2 includes one or more input/output (‘I/O’) adapters (178). I/O adapters in configuration devices implement user-oriented input/output through, for example, software drivers and computer hardware for controlling output to display devices such as computer display screens, as well as user input from user input devices (181) such as keyboards and mice. The exemplary configuration device (100) of FIG. 2 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary configuration device (100) of FIG. 2 includes a communications adapter (167) for data communications with other computers (182) and for data communications with a high speed, low latency data communications network (200). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for generating a global system configuration for a financial market data system according to embodiments of the present invention include modems for wired dial-up communications, IEEE 802.3 Ethernet adapters for wired data communications network communications, and IEEE 802.11b adapters for wireless data communications network communications.

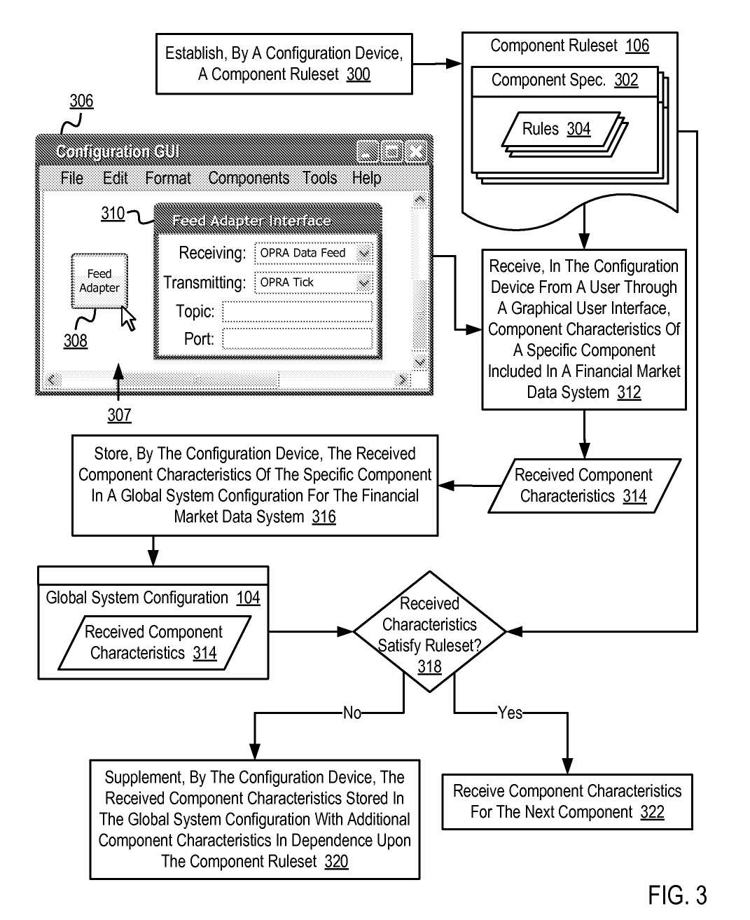

For further explanation, FIG. 3 sets forth a flowchart illustrating an exemplary method for generating a global system configuration for a financial market data system according to embodiments of the present invention. The method of FIG. 3 includes establishing (300), by a configuration device, a component ruleset (106). The component ruleset (106) is a data structure that specifies rules (304) for component characteristics of one or more components capable of being used in financial market data systems. The component ruleset (106) serves as a repository for information regarding the configuration of such components. The component ruleset (106) may specify for a particular component that some component characteristics must be specified by a user if the component is included in a financial market data system, while the specification of other component characteristics by the user is optional. Whether a component characteristics must be specified by a user may change depending on other components included in the financial market data system. In such a manner, the component ruleset (106) may specify a rule for some component characteristics for a particular component in dependence upon the other components included in the system. Furthermore, the component ruleset (106) may also specify a rule that an additional component is required in the financial market data system when a particular component with particular component characteristics is included in the system. The component ruleset (106) of FIG. 3 may be implemented using a structured document, such as, for example, an XML document, a Java object, C++ object, or any other implementation as will occur to those of skill in the art.

A configuration device may establish (300) a component ruleset (106) according to the method of FIG. 3 by storing a component specification (302) for each component capable of being used in financial market data systems in computer memory accessible to the configuration device. Each component specification (302) of FIG. 3 specifies one or more rules (304) for the component characteristics of a particular component capable of being used in financial market data systems. The rules (304) stored in the component ruleset (106) of FIG. 3 may be provided to the configuration device by a system administrator or other user as will occur to those of skill in the art. Readers will note that the computer memory in which the component ruleset (106) is stored may be installed on the configuration device or installed on another device accessible to the configuration device through a data communications connection.

The method of FIG. 3 also includes receiving (312), in the configuration device from a user through a graphical user interface (306), component characteristics (304) of a specific component included in a financial market data system. Using a GUI, a user may graphically design a financial market data system by assembling a variety of hardware and software components capable of being used in financial market data systems. In such a manner, the user may customize a financial market data system meet particular customer requirements and solve business process domain problems. Consider, for example, a configuration GUI (306) illustrated in the example of FIG. 3. The configuration GUI (306) of FIG. 3 provides a window (307) that represents a financial market data system. Adding or removing components in the window (307) represents adding or removing, respectively, components in a financial market data system. Components may be added to the window (307) from a list of potential components (not shown) capable of being used in financial market data systems or through the ‘Components’ menu displayed in the configuration GUI (306). In the example of FIG. 3, a user has added a feed adapter (308) to the financial market data system of window (307).

Upon adding the feed adapter (308) to the financial market data system of window (307), the configuration device displays a dialogue box (310) to allow the user to provide the component characteristics (314) of the feed adapter (308) in the financial market data system of window (307). In the example of FIG. 3, the dialogue box (310) allows the user to define the feed adapter interface by selecting message models used to interpret ticks on the receiving interface and the transmitting interface of the feed adapter (308). The dialogue box (310) of FIG. 3 also allows the user to define the topic and the port used in transmission of ticks. A topic represents the characteristics of the messages that the feed adapter (308) transmits. Using a topic, a user may specify the group of messages for transmission from the feed adapter (308). In a financial market data system, for example, a user may use a topic to specify ticks from an OPRA feed source that contains quotes of an IBM option traded on the Chicago Board Options Exchange (‘CBOE’) that includes the best bid and best ask for the IBM option on the CBOE. In addition to receiving component characteristics from a user through the dialogue window (310), the configuration device may also receive component characteristics through other GUI elements when the user selects items in the ‘Components’ menu on the configuration GUI (306).

The method of FIG. 3 also includes storing (316), by the configuration device, the received component characteristics (314) of the specific component in a global system configuration (104) for the financial market data system. The global system configuration (104) of FIG. 3 is a data structure that specifies the configuration of a financial market data system and its constituent components. The configuration device may store (316) the received component characteristics (314) of the specific component in a global system configuration (104) according to the method of FIG. 3 by formatting the received components characteristics (314) to comport with the format for the global system configuration (104) and inserting the received component characteristics (314) into the global system configuration (104). For further explanation, consider the following exemplary global system configuration implemented in XML:

| | |
|---|---|
| 1: | <global_system_configuration> |
| 2: | <feed_adapter> |
| 3: | <FAID value = “FA1”/> |
| 4: | <Name value = “OPRA Feed Adapter”/> |
| 5: | <FA_interface> |
| 6: | <Owner value = “HAL1”/> |
| 7: | <FA_interface_receiving> |
| 8: | <Model value = “OPRA Data Feed”/> |
| 9: | </FA_interface_receiving> |
| 10: | <FA_interface_transmitting> |
| 11: | <Model value = “OPRA Tick”/> |
| 12: | </FA_interface_transmitting> |
| 13: | </FA_interface> |
| 14: | <FA_transport> |
| 15: | <Port value = “34341”/> |
| 16: | <MulticastGroup value = “239.255.64.3”/> |
| 17: | <MulticastTopic value = “S”/> |
| 18: | </FA_transport> |
| 19: | </feed_adapter> |
| ... | ... |
| 40: | </global_system_configuration> |

In the example above, lines 1 and 40 contain markup tags that denote the beginning and the end, respectively, of the exemplary global system configuration. Lines 2 and 19 contain markup tags that denote the beginning and the end, respectively, of the exemplary characteristics of a feed adapter included in the exemplary financial market data system. Line 3 specifies the identifier for the feed adapter, while line 4 specifies the name of the feed adapter. Lines 5 through 13 specify characteristics regarding the interfaces of the feed adapter. Lines 14 through 18 specify characteristics regarding the transport component for the feed adapter. Readers will note that the exemplary global system configuration above is for explanation and not for limitation. Other global system configuration as will occur to those of skill in the art may also be used to generate a global system configuration for a financial market data system according to embodiments of the present invention. Readers will also note that the XML implementation, the markup tags, and structure of the exemplary global system configuration above are also for explanation and not for limitation. Many other implementations, markup tags, or structures may be used to implement global system configurations useful according to embodiments of the present invention.

The method of FIG. 3 includes determining (318), by the configuration device, whether the received component characteristics (314) satisfy the component ruleset (106). The configuration device may determine (318) whether the received component characteristics (314) satisfy the component ruleset (106) according to the method of FIG. 3 by determining whether the received component characteristics (314) for the specific component stored in the global system configuration (104) satisfy each rule (304) for the specification (302) of the specific component in component ruleset (106). For example, if the rules in the component rule (106) for the specific component require the feed adapter to have a name, then the received component characteristics (314) will not satisfy the component ruleset (106) unless a name is specified for the feed adapter in the received component characteristics (314). If the received component characteristics (314) for the specific component stored in the global system configuration (104) satisfy each rule (304) for the specification (302) of the specific component in component ruleset (106), then the received component characteristics (314) satisfy the component ruleset (106). The received component characteristics (314), however, do not satisfy the component ruleset (106) if the received component characteristics (314) for the specific component stored in the global system configuration (104) do not satisfy each rule (304) for the specification (302) of the specific component in component ruleset (106).

The method of FIG. 3 also includes receiving (322), by the configuration device, component characteristics for the next component if the received component characteristics (314) satisfy the component ruleset (106). The configuration device may receive (322) component characteristics for the next component according to the method of FIG. 3 by displaying a list of potential components that may be included in financial market data systems.

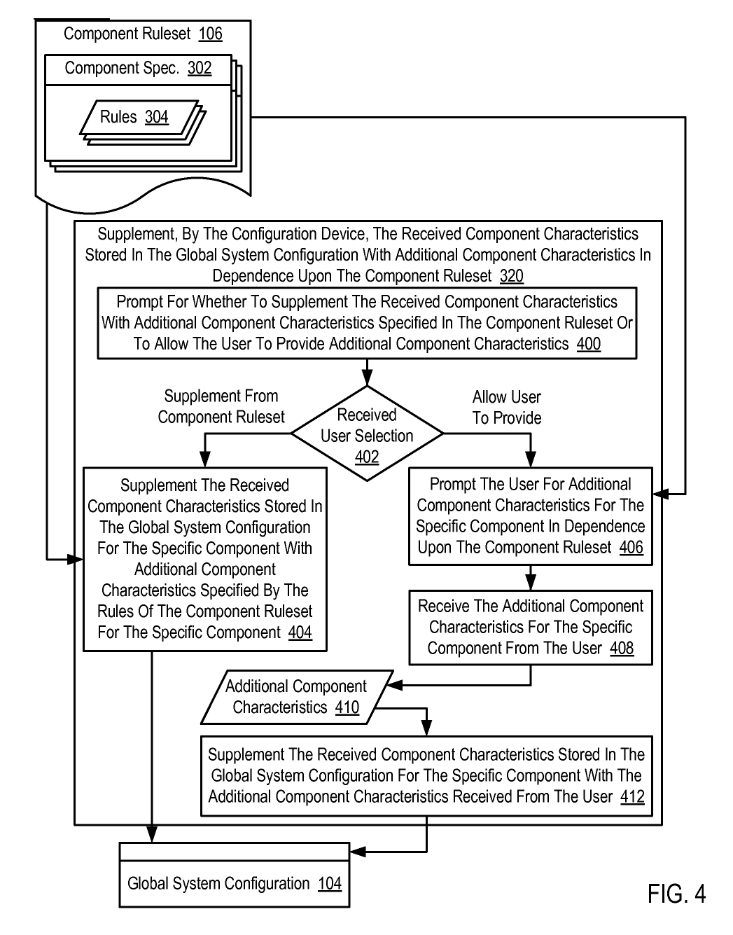

The method of FIG. 3 includes supplementing (320), by the configuration device, the received component characteristics (314) stored in the global system configuration (104) with additional component characteristics in dependence upon the component ruleset (106) if the received component characteristics (314) do not satisfy the component ruleset (106). The configuration device may supplement (320) the received component characteristics (314) stored in the global system configuration (104) with additional component characteristics in dependence upon the component ruleset (106) according to the method of FIG. 4 by supplementing the received component characteristics (314) stored in the global system configuration (104) for the specific component with additional component characteristics specified by the rules (304) of the component ruleset (106) for the specific component as described below in more detail with reference to FIG. 4. The configuration device may also supplement (320) the received component characteristics (314) stored in the global system configuration (104) with additional component characteristics in dependence upon the component ruleset (106) according to the method of FIG. 4 by prompting the user for additional component characteristics for the specific component in dependence upon the component ruleset (106), receiving the additional component characteristics for the specific component from the user, and supplementing the received component characteristics (314) stored in the global system configuration (104) for the specific component with the additional component characteristics received from the user as described below in more detail with reference to FIG. 4.

To determine whether to supplement the received component characteristics for the specific component with the component characteristics specified in the component ruleset or to allow the user to provide additional component characteristics for the specific component, the configuration device may display a prompt to receive a user selection. For further explanation, therefore, FIG. 4 sets forth a flowchart illustrating an exemplary method for supplementing (320), by the configuration device, the received component characteristics stored in the global system configuration (104) with additional component characteristics in dependence upon the component ruleset (106) if the received component characteristics do not satisfy the component ruleset (106) useful in generating a global system configuration for a financial market data system according to embodiments of the present invention that includes prompting (400) the user for whether to supplement the received component characteristics for the specific component with additional component characteristics specified in the component ruleset or to allow the user to provide additional component characteristics for the specific component.

The configuration device may prompt (400) the user according to the method of FIG. 4 by displaying a dialogue box (not shown) that indicates to the user that the received component characteristics (314) do not satisfy the component ruleset (106). The dialogue box may provide buttons that allow the user to provide a selection of whether to supplement the received component characteristics for the specific component with additional component characteristics specified in the component ruleset or to allow the user to provide additional component characteristics for the specific component. One button may correspond to a user's indication to supplement the received component characteristics for the specific component with additional component characteristics specified in the component ruleset. Another button may correspond to a user's indication to allow the user to provide additional component characteristics for the specific component.

The method of FIG. 4 also includes determining (402) whether the received user selection indicates to supplement the received component characteristics for the specific component with additional component characteristics specified in the component ruleset or to allow the user to provide additional component characteristics for the specific component. The configuration device may determine (402) whether the received user selection indicates to supplement the received component characteristics with additional component characteristics specified in the component ruleset or to allow the user to provide additional component characteristics according to method of FIG. 4 by identifying which button a user selects in the dialogue box mentioned above.

The method of FIG. 4 includes supplementing (404) the received component characteristics stored in the global system configuration (104) for the specific component with additional component characteristics specified by the rules (304) of the component ruleset (106) for the specific component if the received user selection indicates to supplement from the component ruleset (106). Readers will note that the component ruleset (106) in the example of FIG. 4 is similar to the component ruleset of FIG. 3. The component ruleset (106) of FIG. 4 includes a component specification (302) for one or more components capable of being used in financial market data systems. Each component specification (302) of FIG. 4 specifies one or more rules (304) for the component characteristics of a particular component capable of being used in financial market data systems.

The configuration device may supplement (404) the received component characteristics stored in the global system configuration (104) for the specific component with the component characteristics specified by the rules (304) of the component ruleset (106) for the specific component according to the method of FIG. 4 by identifying the component characteristics missing from the received component characteristics using the rules (304) of the component ruleset (106) for the specific component, and inserting default component characteristics from the component ruleset (106) into the global system configuration (104) for the missing component characteristics. For example, consider that the rules (304) of the component ruleset (106) for a feed adapter specify that transport and high availability component characteristics of the feed adapter must be specified. Further consider that the transport and high availability component characteristics are missing from the received component characteristics for such a feed adapter. In such an example, the configuration device may then supplement the received component characteristics stored in the global system configuration (104) with default transport and high availability component characteristics from the component ruleset (106).

The method of FIG. 4 also includes prompting (406) the user for additional component characteristics for the specific component in dependence upon the component ruleset (106) if the received user selection indicates to allow the user to provide additional component characteristics. The configuration device may prompt (406) the user for additional component characteristics for the specific component according to the method of FIG. 4 by identifying the component characteristics missing from the received component characteristics using the rules (304) of the component ruleset (106) for the specific component, and displaying a dialogue box that requests the user to provide the missing component characteristics. For example, consider that the rules (304) of the component ruleset (106) for a feed adapter specify that at least one topic for the application messages transmitted by the feed adapter must be specified. Further consider that the received component characteristics for such a feed adapter do not specify a topic. In such an example, the configuration device may prompt the user for additional component characteristics that specify at least one topic for the feed adapter.

The method of FIG. 4 include receiving (408) the additional component characteristics (410) for the specific component from the user. The configuration device may receive (408) the additional component characteristics (410) for the specific component from the user according to the method of FIG. 4 by accepting text or selections from the user in the dialogue box mentioned above.

The method of FIG. 4 also includes supplementing (412) the received component characteristics stored in the global system configuration (104) for the specific component with the additional component characteristics (410) received from the user. The configuration device may supplement (412) the received component characteristics stored in the global system configuration (104) according to the method of FIG. 4 by inserting the additional component characteristics (410) into the global system configuration (104) along with the received component characteristics.

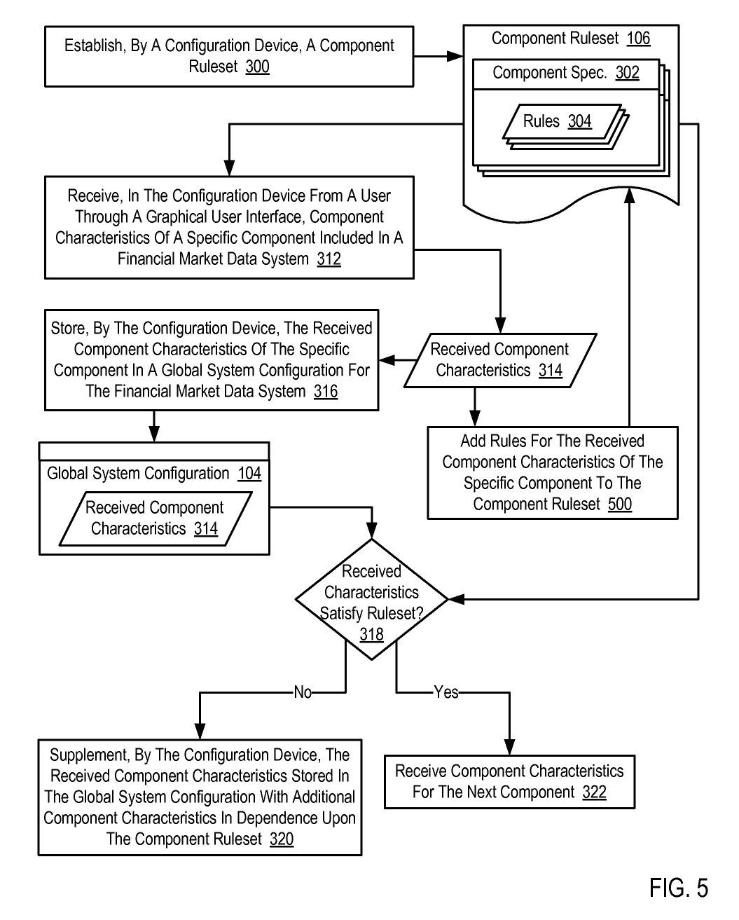

Occasionally a user may want to add a new component to a financial market data system that is not described in the component ruleset. When the user provides component characteristics for such a new component, the configuration device may add rules for the received component characteristics of the specific component to the component ruleset. For further explanation, therefore, FIG. 5 sets forth a flowchart illustrating a further exemplary method for generating a global system configuration for a financial market data system according to embodiments of the present invention that includes adding (500) rules for the received component characteristics (314) of the specific component to the component ruleset (106).

The method of FIG. 5 is similar to the method of FIG. 3. That is, the method of FIG. 5 includes establishing (300), by a configuration device, a component ruleset (106), receiving (312), in the configuration device from a user through a graphical user interface (306), component characteristics (304) of a specific component included in a financial market data system, storing (316), by the configuration device, the received component characteristics (314) of the specific component in a global system configuration (104) for the financial market data system, determining (318), by the configuration device, whether the received component characteristics (314) satisfy the component ruleset (106), receiving (322) component characteristics for the next component if the received component characteristics (314) satisfy the component ruleset (106), and supplementing (320), by the configuration device, the received component characteristics (314) stored in the global system configuration (104) with additional component characteristics in dependence upon the component ruleset (106) if the received component characteristics do not satisfy the component ruleset (106). In the example of FIG. 5, the component ruleset (106) includes component specifications (302) that specify rules (304) for component characteristics of one or more components capable of being used in financial market data systems.

The method of FIG. 5 also includes adding (500), by the configuration device, rules for the received component characteristics (314) of the specific component to the component ruleset (106). In accordance with how the user provided the component characteristics, the configuration device may add (500) rules that specify whether each of the received component characteristics (314) is required or optional, rules that specify that the received component characteristics (314) are default value of the specific component, rules that specify the received component characteristics (314) are only required when another particular component is also included in the financial market data system, or any other rules as will occur to those of skill in art. By adding rules for the received component characteristics (314) of the specific component, the configuration device will have the ability to valid the component characteristics received on subsequent occasions when the user adds this new specific component to a financial market data system.

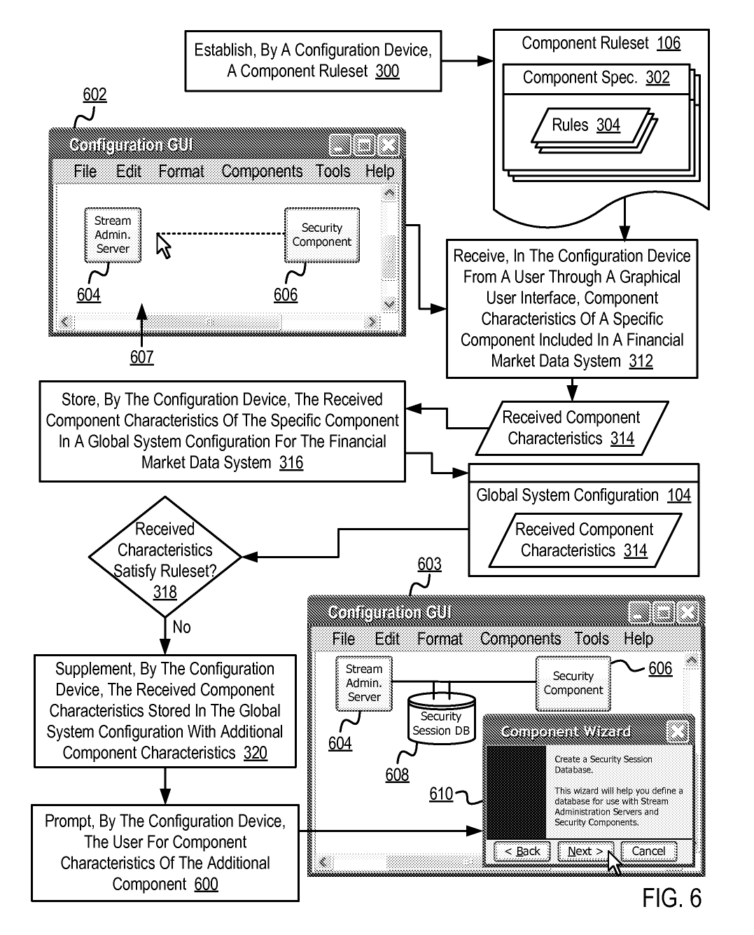

As mentioned above, the component ruleset may specify a rule that an additional component is required in the financial market data system when a user adds a particular component with particular component characteristics. For further explanation, therefore, FIG. 6 sets forth a flowchart illustrating a further exemplary method for generating a global system configuration for a financial market data system according to embodiments of the present invention that includes prompting (600), by the configuration device, the user for component characteristics of the additional component.

The method of FIG. 6 is similar to the method of FIG. 3. That is, the method of FIG. 6 includes establishing (300), by a configuration device, a component ruleset (106), receiving (312), in the configuration device from a user through a graphical user interface (306), component characteristics (304) of a specific component included in a financial market data system, storing (316), by the configuration device, the received component characteristics (314) of the specific component in a global system configuration (104) for the financial market data system, determining (318), by the configuration device, whether the received component characteristics (314) satisfy the component ruleset (106), and supplementing (320), by the configuration device, the received component characteristics (314) stored in the global system configuration (104) with additional component characteristics in dependence upon the component ruleset (106) if the received component characteristics do not satisfy the component ruleset (106). In the example of FIG. 6, the component ruleset (106) includes component specifications (302) that specify rules (304) for component characteristics of one or more components capable of being used in financial market data systems.

In the example of FIG. 6, the configuration device receives component characteristics through a configuration GUI (602). Through the configuration GUI (602) of FIG. 6, a user has added a stream administration server (604) and a security component (606) to a window (607) that represents a financial market data system. By drawing a line between the stream administration server (604) and the security component (606) in the window (607), the user is providing a logical connection between the two components. That is, the user is defining that one of the component characteristics of the stream administration server (604) is that the stream administration server (604) is connected to a security component. With the same line, the user also defines that one of the component characteristics of the security component (606) is that the security component (606) is connected to a stream administration server.

In the example of FIG. 6, the component ruleset (106) specifies rules for some of the component characteristics of the specific component in dependence upon another component. Consider, for example, that the specific component for which component characteristics are received is the security component (606). The component ruleset (106) may include a rule for the security component that is connected to a stream administration server that requires the public encryption key of the stream administration server to be provided to the security component. Without specifying the public encryption key of the stream administration server, the component characteristics received from the user for the security component (606) do not satisfy the component ruleset (106). As such, the configuration device may supplement the received component characteristics for the security component (606) by allowing the user to provide the public encryption key for the security component (606).

The component ruleset (106) of FIG. 6 also specifies a rule that an additional component is required in the financial market data system for the specific component. Continuing with the example from above, consider that the specific component for which component characteristics are received by the configuration device is the security component (606). Further consider that the component ruleset (106) includes a rule that a security session database is required in the financial market data system for a security component that is connected to a stream administration server. In the example of FIG. 6, therefore, the configuration device would determine that the received component characteristics for the security component (606) do not satisfy the component ruleset (106) because the configuration GUI (602) does not include a security session database.

The method of FIG. 6 includes prompting (600), by the configuration device, the user for component characteristics of the additional component if the received component characteristics do not satisfy the component ruleset (106). The configuration device may prompt (600) the user for component characteristics of the additional component according to the method of FIG. 6 by using a dialogue box or a GUI wizard. The example of FIG. 6 includes a configuration GUI (603) in which the configuration device has added the security session database (608) specified by the component ruleset (106) for the security component (606). In the example of FIG. 6, the configuration device prompts (600) the user for the component characteristics of the security session database (608) using a component wizard (610). Prompting the user for component characteristics of the additional component according to the example of FIG. 6 advantageously ensures that the global system configuration is properly specified for the particular financial market data system because the configuration device validates the global system configuration (104) against the component ruleset (106).

In view of the explanations set forth above in this document, readers will recognize that generating a global system configuration for a financial market data system according to embodiments of the present invention provides the following benefits:
the ability to validate a global system configuration against a component ruleset,
the ability to supplement the data in a global system configuration as necessary using data from the component ruleset, and
the ability to prompt a user to provide missing data in a global system configuration as necessary according to the component ruleset.

Exemplary embodiments of the present invention are described largely in the context of a fully functional computer system for generating a global system configuration for a financial market data system. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of generating a global system configuration for a financial market data system, the method comprising:
establishing, by a configuration device, a component ruleset, the component ruleset specifying rules for component characteristics of one or more components capable of being used in financial market data systems;
receiving, in the configuration device from a user through a graphical user interface, component characteristics of a specific component included in a financial market data system;
storing, by the configuration device, the received component characteristics of the specific component in a global system configuration for the financial market data system;
determining, by the configuration device, whether the received component characteristics satisfy the component ruleset; and
supplementing, by the configuration device, the received component characteristics stored in the global system configuration with additional component characteristics in dependence upon the component ruleset if the received component characteristics do not satisfy the component ruleset.

2. The method of claim 1 wherein supplementing, by the configuration device, the received component characteristics stored in the global system configuration with additional component characteristics in dependence upon the component ruleset if the received component characteristics do not satisfy the component ruleset further comprises supplementing the received component characteristics stored in the global system configuration for the specific component with additional component characteristics specified by the rules of the component ruleset for the specific component.

3. The method of claim 1 wherein supplementing, by the configuration device, the received component characteristics stored in the global system configuration with additional component characteristics in dependence upon the component ruleset if the received component characteristics do not satisfy the component ruleset further comprises:
prompting the user for additional component characteristics for the specific component in dependence upon the component ruleset;
receiving the additional component characteristics for the specific component from the user; and
supplementing the received component characteristics stored in the global system configuration for the specific component with the additional component characteristics received from the user.

4. The method of claim 1 wherein supplementing, by the configuration device, the received component characteristics stored in the global system configuration with additional component characteristics in dependence upon the component ruleset if the received component characteristics do not satisfy the component ruleset further comprises prompting the user for whether to supplement the received component characteristics for the specific component with additional component characteristics specified in the component ruleset or to allow the user to provide additional component characteristics for the specific component.

5. The method of claim 1 further comprising adding, by the configuration device, rules for the received component characteristics of the specific component to the component ruleset.

6. The method of claim 1 wherein:
the financial market data system further comprises an other component; and
the component ruleset specifies rules for component characteristics of the specific component in dependence upon the other component.

7. The method of claim 1 wherein the component ruleset specifies a rule that an additional component is required in the financial market data system for the specific component, the method further comprising prompting, by the configuration device, the user for component characteristics of the additional component.

8. An apparatus for generating a global system configuration for a financial market data system, the apparatus comprising a computer processor, a computer memory operatively coupled to the computer processor, the computer memory having disposed within it computer program instructions capable of:
establishing, by a configuration device, a component ruleset, the component ruleset specifying rules for component characteristics of one or more components capable of being used in financial market data systems;
receiving, in the configuration device from a user through a graphical user interface, component characteristics of a specific component included in a financial market data system;
storing, by the configuration device, the received component characteristics of the specific component in a global system configuration for the financial market data system;
determining, by the configuration device, whether the received component characteristics satisfy the component ruleset; and
supplementing, by the configuration device, the received component characteristics stored in the global system configuration with additional component characteristics in dependence upon the component ruleset if the received component characteristics do not satisfy the component ruleset.

9. The apparatus of claim 8 wherein supplementing, by the configuration device, the received component characteristics stored in the global system configuration with additional component characteristics in dependence upon the component ruleset if the received component characteristics do not satisfy the component ruleset further comprises supplementing the received component characteristics stored in the global system configuration for the specific component with additional component characteristics specified by the rules of the component ruleset for the specific component.

10. The apparatus of claim 8 wherein supplementing, by the configuration device, the received component characteristics stored in the global system configuration with additional component characteristics in dependence upon the component ruleset if the received component characteristics do not satisfy the component ruleset further comprises:
prompting the user for additional component characteristics for the specific component in dependence upon the component ruleset;
receiving the additional component characteristics for the specific component from the user; and
supplementing the received component characteristics stored in the global system configuration for the specific component with the additional component characteristics received from the user.

11. The apparatus of claim 8 further comprising computer program instructions capable of adding, by the configuration device, rules for the received component characteristics of the specific component to the component ruleset.

12. The apparatus of claim 8 wherein:
the financial market data system further comprises an other component; and
the component ruleset specifies rules for component characteristics of the specific component in dependence upon the other component.

13. The apparatus of claim 8 wherein the component ruleset specifies a rule that an additional component is required in the financial market data system for the specific component, the apparatus further comprising computer program instructions capable of prompting, by the configuration device, the user for component characteristics of the additional component.

14. A computer program product for generating a global system configuration for a financial market data system, the computer program product disposed upon a recordable medium, the computer program product comprising computer program instructions capable of:
establishing, by a configuration device, a component ruleset, the component ruleset specifying rules for component characteristics of one or more components capable of being used in financial market data systems;
receiving, in the configuration device from a user through a graphical user interface, component characteristics of a specific component included in a financial market data system;
storing, by the configuration device, the received component characteristics of the specific component in a global system configuration for the financial market data system;
determining, by the configuration device, whether the received component characteristics satisfy the component ruleset; and
supplementing, by the configuration device, the received component characteristics stored in the global system configuration with additional component characteristics in dependence upon the component ruleset if the received component characteristics do not satisfy the component ruleset.

15. The computer program product of claim 14 wherein supplementing, by the configuration device, the received component characteristics stored in the global system configuration with additional component characteristics in dependence upon the component ruleset if the received component characteristics do not satisfy the component ruleset further comprises supplementing the received component characteristics stored in the global system configuration for the specific component with additional component characteristics specified by the rules of the component ruleset for the specific component.

16. The computer program product of claim 14 wherein supplementing, by the configuration device, the received component characteristics stored in the global system configuration with additional component characteristics in dependence upon the component ruleset if the received component characteristics do not satisfy the component ruleset further comprises:
prompting the user for additional component characteristics for the specific component in dependence upon the component ruleset;
receiving the additional component characteristics for the specific component from the user; and
supplementing the received component characteristics stored in the global system configuration for the specific component with the additional component characteristics received from the user.

17. The computer program product of claim 14 wherein supplementing, by the configuration device, the received component characteristics stored in the global system configuration with additional component characteristics in dependence upon the component ruleset if the received component characteristics do not satisfy the component ruleset further comprises prompting the user for whether to supplement the received component characteristics for the specific component with additional component characteristics specified in the component ruleset or to allow the user to provide additional component characteristics for the specific component.

18. The computer program product of claim 14 further comprising computer program instructions capable of adding, by the configuration device, rules for the received component characteristics of the specific component to the component ruleset.

19. The computer program product of claim 14 wherein:
the financial market data system further comprises an other component; and
the component ruleset specifies rules for component characteristics of the specific component in dependence upon the other component.

20. The computer program product of claim 14 wherein the component ruleset specifies a rule that an additional component is required in the financial market data system for the specific component, the computer program product further comprising computer program instructions capable of prompting, by the configuration device, the user for component characteristics of the additional component.
